(19) United States
(12) Patent Application Publication
(10) Pub. No.: US 2025/0232224 A1
(43) Pub. Date: Jul. 17, 2025

(54) METHOD FOR TRAINING AN ARTIFICIAL INTELLIGENCE MODEL AND ASSOCIATED COMPUTER PROGRAM

(71) Applicants: BULL SAS, LES CLAYES-SOUS-BOIS (FR); INSTITUT NATIONAL POLYTECHNIQUE DE TOULOUSE, TOULOUSE cedex 4 (FR); UNIVERSITE de TOULOUSE, Toulouse Cedex 9 (FR); CENTRE NATIONAL DE LA RECHERCHE SCIENTIFIQUE, PARIS (FR); SORBONNE UNIVERSITE, PARIS (FR)

(72) Inventors: Théo BEUZEVILLE, Toulouse (FR); Nicolas WINCKLER, Villard Bonnot (FR); Alfredo BUTTARI, Toulouse (FR); Serge GRATTON, Toulouse (FR); Theo MARY, Charbonnières-Les-Bains (FR)

(73) Assignees: BULL SAS, LES CLAYES-SOUS-BOIS (FR); INSTITUT NATIONAL POLYTECHNIQUE DE TOULOUSE, TOULOUSE cedex 4 (FR); UNIVERSITE de TOULOUSE, Toulouse Cedex 9 (FR); CENTRE NATIONAL DE LA RECHERCHE SCIENTIFIQUE, PARIS (FR); SORBONNE UNIVERSITE, PARIS (FR)

(21) Appl. No.: 19/023,975

(22) Filed: Jan. 16, 2025

(30) Foreign Application Priority Data
Jan. 16, 2024 (EP) 24305104.2

(51) Int. Cl. G06N 20/00

(52) U.S. Cl. CPC G06N 20/00

(57) ABSTRACT

The invention relates to a computer-implemented method for training an artificial intelligence model based on a training dataset. The method includes iteratively performing a training loop for training the artificial intelligence model based on a current subset of the training dataset and on a current condition number of the artificial intelligence model, to update the artificial intelligence model.

This application claims priority to European Patent Application Number 24305104.2, filed 16 Jan. 2024, the specification of which is hereby incorporated herein by reference.

### BACKGROUND OF THE INVENTION

### Field of the Invention

At least one embodiment of the invention relates to a computer-implemented method for training an artificial intelligence model based on a training dataset.

At least one embodiment of the invention further relates to a computer program.

One or more embodiments of the invention applies to the field of computer science, and more precisely to the field of artificial intelligence.

### Description of the Related Art

Artificial intelligence models (hereinafter, “AI models”), such as deep neural networks, have become increasingly popular and successful in several tasks, as their efficiency in solving complex problems has kept increasing up to a level where AI models are now used to perform safety-critical tasks such as autonomous driving and medicine.

Such AI models may require training (also referred to as “supervised machine learning”). During such training, a training dataset including examples is provided, each example comprising an input associated with a corresponding expected output. Then, the AI model is provided with the inputs of the dataset, and, for each input, a difference between the corresponding expected output and the output provided by the AI model is monitored, generally through a loss function. Furthermore, the parameters of the AI model are modified based on said difference, so as to minimize the latter.

An issue in supervised machine learning is over-fitting. Over-fitting is defined as the fact that an AI model does not generalize well from the training data to unseen data. For instance, over-fitting may occur when the AI model is trained for too long, thereby providing predictions that fit perfectly the training dataset, while being unable to capture information or to generalize on new data.

As a result, an over-fitted artificial intelligence model may prove to be sensitive to perturbations, such as adversarial attacks. Indeed, such adversarial attacks usually rely on small modifications in data that are known to the trained artificial intelligence model to lead to a specific output of the AI model that dramatically differs from the expected output associated with said known data. Such adversarial attacks may be particularly prejudicial, for instance in the field of classification.

Early stopping has been considered as a way to prevent over-fitting.

By “early stopping”, it is meant, in the context of one or more embodiments of the invention, stopping the training of the AI model at the early stopping point, i.e., the point at which the accuracy on a validation set stops increasing.

Indeed, it has been shown that if the AI model continues learning after the early stopping point, the validation error will increase while the training error will continue decreasing, which is typical of over-fitting.

Practically, to find out the point to stop learning, the obvious way is to keep track of accuracy on the test data as the AI model is trained.

However, such method is not fully satisfactory.

Indeed, early stopping generally requires that performances of the AI model being trained are regularly assessed based on the validation dataset in order to detect the point at which the accuracy on the validation set stops increasing, which may be cumbersome.

Moreover, early stopping is often associated with the drawback of stopping the training too early. Consequently, potential optimal points for the training of the AI model are missed.

A purpose of at least one embodiment of the invention is to overcome at least one of these drawbacks.

Another purpose of at least one embodiment of the invention is to provide a method for training an artificial intelligence model that, based on a given training dataset, prevents over-fitting while being simple to implement.

Another purpose of at least one embodiment of the invention is to provide a training method that, when performed, provides a robust artificial intelligence model.

### BRIEF SUMMARY OF THE INVENTION

To this end, at least one embodiment of the invention is a training method of the aforementioned type, including iteratively performing a training loop for training the artificial intelligence model based on a current subset of the training dataset and on a current condition number of the artificial intelligence model, to update the artificial intelligence model.

Indeed, the inventors have discovered that the condition number of an artificial intelligence model is directly linked with over-fitting during training. More precisely, the inventors have discovered that an increasing condition number corresponds to over-fitting.

Consequently, training the artificial intelligence model based on the condition number allows to prevent over-fitting and to obtain more robust artificial intelligence models compared to known training techniques.

According to one or more embodiments of the invention, the method includes one or several of the following features, taken alone or in any technically possible combination:
the training loop comprises a decision step for determining, based on the current condition number of the artificial intelligence model, whether an over-fitting condition is reached, the training loop further comprising, based on a result of the determination, performing:
an adjustment step for adjusting parameters of the artificial intelligence model based on the current subset of the training dataset if the over-fitting condition is not reached; or
a stopping step for stopping the training of the artificial intelligence model, if the over-fitting condition is reached;
the decision step includes comparing the current condition number to the condition number associated with at least one previous iteration of the training loop, the over-fitting condition being reached if an increase in the condition number is detected;
the stopping step further includes outputting, as a trained model, an instance of the artificial intelligence model associated with the lowest condition number;
for each iteration of the training loop, computing the condition number includes:
computing, for each variable X associated with the current subset of the training dataset, a corresponding condition number as:

$${κ}_{f} ( X ) = \frac{‖ {𝒥}_{f} ( X ) ‖ ‖ \vec{X} ‖}{‖ γ ‖}$$

where:
   κ_{f}(X) is the condition number corresponding to variable X;
   [symbol] (X) is a Jacobian matrix of the artificial intelligence model with respect to variable X;
   y is an output of the artificial intelligence model corresponding to variable X;
   X is a variable including at least an input x of the current subset of the training dataset and, preferably, at least part of the parameters of the artificial intelligence model;
   \vec{X} is a vectorized version of variable X; and
determining the condition number, for the current subset, based on the condition number computed for each variable X associated with the current subset;
the training loop comprises an optimization step for adjusting parameters of the artificial intelligence model, based on the current subset of the training dataset, to minimize a loss function that is an increasing function of the condition number of the artificial intelligence model;
the loss function is equal to a sum of:
a first term that is an increasing function of a difference between, on the one hand, an output of the artificial intelligence model to a corresponding received input, and, on the other hand, an expected output associated with said received input;
a second term that is an increasing function of the condition number.

According to at least one embodiment of the invention, it is proposed a computer program comprising instructions, which when executed by a computer, cause the computer to carry out the steps of the method as defined above.

The computer program may be in any programming language such as C, C++, JAVA, Python, etc.

The computer program may be in machine language.

The computer program may be stored, in a non-transient memory, such as a USB stick, a flash memory, a hard-disc, a processor, a programmable electronic chop, etc.

The computer program may be stored in a computerized device such as a smartphone, a tablet, a computer, a server, etc.

### BRIEF DESCRIPTION OF THE DRAWINGS

Other advantages and characteristics will become apparent on examination of the detailed description of at least one embodiment which is in no way limitative, and the attached figures, where:

FIG. 1 is a schematic representation of a computer configured to perform a training method according to one or more embodiments of the invention;

FIG. 2 is a flowchart of a first example of the training method according to one or more embodiments of the invention;

FIG. 3 is a graph showing the evolution of the condition number of an artificial intelligence model as a function of a number of iterations of a training loop of the training method of FIG. 2, according to one or more embodiments of the invention; and

FIG. 4 is a flowchart of a second example of the training method according to one or more embodiments of the invention.

### DETAILED DESCRIPTION OF THE INVENTION

It is well understood that the one or more embodiments that will be described below are in no way limitative. In particular, it is possible to imagine variants of the one or more embodiments of the invention comprising only a selection of the characteristics described hereinafter, in isolation from the other characteristics described, if this selection of characteristics is sufficient to confer a technical advantage or to differentiate the one or more embodiments of the invention with respect to the state of the prior art. Such a selection comprises at least one, preferably functional, characteristic without structural details, or with only a part of the structural details if this part alone is sufficient to confer a technical advantage or to differentiate the one or more embodiments of the invention with respect to the prior art.

In the FIGURES, elements common to several figures retain the same reference.

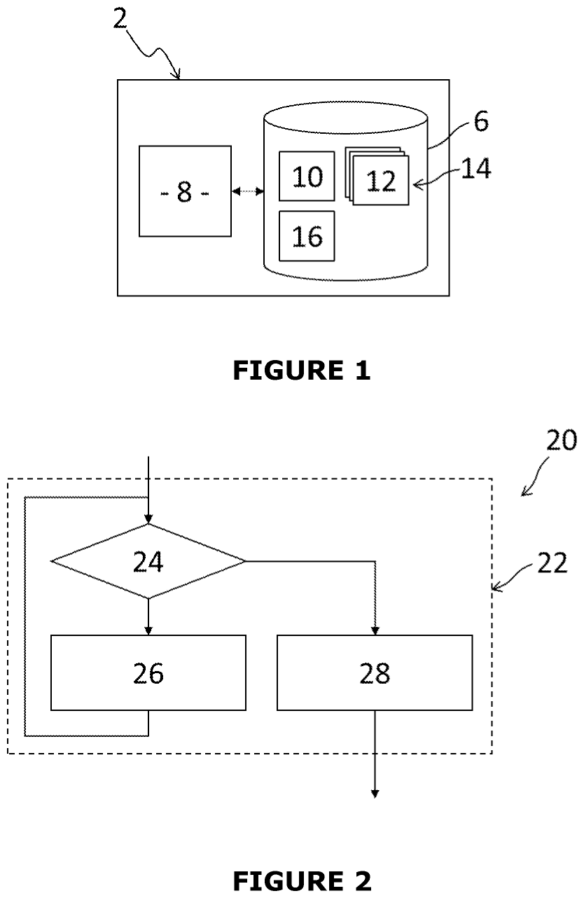

A computer 2 configured to perform a training method according to one or more embodiments of the invention, for training an artificial intelligence model, is shown on FIG. 1.

The computer 2 includes a memory 6 and a processing unit 8.

The memory 6 is configured to store a training dataset 10.

As known to the person skilled in the art, the training dataset 10 preferably includes at least one example, each example comprising an input associated with at least one corresponding expected output. Such expected output may also be referred to as “label”.

For instance, in the case where the training dataset 10 is designed for the training of a classification model, the training dataset 10 comprises a plurality of images. In this case, for each image, each corresponding label is representative of a class to which belongs a respective object depicted (i.e., shown) in said image.

The memory 6 is also configured to store the aforementioned artificial intelligence model 12 (hereinafter, “model”).

Preferably, in at least one embodiment, the artificial intelligence model 12 is a classification model, such as a classification neural network. Indeed, the inventors have found that the training method according to one or more embodiments of the invention is particularly suitable for training a classification model. In this case, the artificial intelligence model 12 is configured to provide, for each image provided as input, a class for each object detected in said input image.

Preferably, in at least one embodiment, the memory 6 is also configured to store, for at least one iteration of a training loop (described below) of the training method, a respective instance of the model 12 obtained after said iteration of the training loop. On FIG. 1, in at least one embodiment, the successive instances of the model 12 are shown as a pile 14.

Preferably, in at least one embodiment, the memory 6 is further configured to store a trained model 16, which corresponds to the instance of the model 12 that is available once the training method (having reference 20 on FIG. 2) is performed.

As mentioned previously, in order to train the model 12, the computer 2 is configured to perform the aforementioned training method 20 (FIG. 2).

The training method 20 includes a training loop 22 for iteratively training the model 12.

More precisely, in at least one embodiment, each iteration of the training loop 22 comprises training the model 12 based on a corresponding current subset of the training dataset 10, as well as based on a current condition number of the model 12. Consequently, performing each training loop 22 results in an updated model 12.

By “condition number” (or “conditioning”) of a function (such as an artificial intelligence model), it is meant, in the context of one or more embodiments of the invention, a quantity that is representative of the sensitivity of the function to perturbations in the input data. More precisely, in at least one embodiment, the condition number is representative of the relative change in the output of the function for a given relative change in the input.

Consequently, in at least one embodiment, a low condition number is indicative of a well-posed problem. Therefore, in the context of enhancing robustness and preventing over-fitting, a low condition number is a desired property in a function (and, more specifically, in a model).

Formally, the condition number of a given function f (such as an artificial intelligence model, for instance) for a given input x is defined as:

$${lim}_{ε \to {0}^{+}} {sup}_{‖ δ x ‖ \leq ε} [ \frac{‖ f ( x + δ x ) - f ( x ) ‖}{‖ f ( x ) ‖} / \frac{‖ δ x ‖}{‖ x ‖} ]$$

where:
   “lim” is the limit operator;
   “sup” is the supremum operator;
   ε is a strictly positive real number;
   δx is a perturbation in the input; and
   ∥.∥ is the Euclidian norm.

Preferably, in at least one embodiment, the processing unit 8 is configured to perform each iteration of the training loop 22 based on a respective subset of the training dataset 10. In other words, the subset of the training dataset 10 which is used for training the model 12 preferably differs from one iteration of the training loop 22 to the other.

As can be seen on FIG. 2, by way of one or more embodiments, the training loop 22 comprises a decision step 24 for determining whether an over-fitting condition is reached. The training loop 22 further comprises an adjustment step 26 and a stopping step 28.

More precisely, in at least one embodiment, the processing unit 8 is configured to determine, during the decision step 24, and based on the current condition number of the model 12, whether an over-fitting condition is reached.

In this case, the processing unit 8 is configured to first compute, during the decision step 24, a condition number κ_{f}(X) of the model 12, based at least on the current subset of the training database 10.

More precisely, the processing unit 8 is configured to compute the condition number κ_{f}(X) as:

$${κ}_{f} ( X ) = \frac{‖ {𝒥}_{f} ( X ) ‖ ‖ \vec{X} ‖}{‖ γ ‖}$$

where:
   [symbol] (X) is a Jacobian matrix of the artificial intelligence model with respect to a variable X;
   the variable X includes, at least, an input x of the current subset of the training database 10, and, preferably, at least part of parameters A of the artificial intelligence model 12;
   y is an output of the artificial intelligence model corresponding to X;
   \vec{X} is a vectorized version of variable X.

For instance, the processing unit 8 may be configured to compute the Jacobian matrix of the model 12 with respect to variable X using a custom implementation using auto-differentiation. As known to the person skilled in the art, auto-differentiation enables to compute partial derivatives of a function (such as an artificial intelligence model) with respect to its input and/or its parameters.

The processing unit 8 is also configured to compute the condition number associated with the current subset of the dataset 10 based on the condition number κ_{f}(X) computed for each input x of said subset.

For instance, in at least one embodiment, the processing unit 8 is configured to compute the condition number for the current subset of the dataset 10 (i.e., for the current instance of the model 12) as an average of the condition numbers κ_{f}(X) computed for the inputs x of said subset.

For instance, in at least one embodiment, in the case where the model 12 is a p-layer neural network, hereinafter noted “f”, and assuming the neural network f is differentiable at input x, the processing unit 8 is configured to compute the condition number, for said variable X (including input x and parameters A), based on the corresponding output y of the neural network, formally defined as:

$$γ = {f}_{p} ( {A}_{p} {f}_{p - 1} ( {A}_{p - 1} … {A}_{2} {f}_{1} ( {A}_{1} x ) … ) )$$

where:
   fᵢ is the activation function of the i^{th} layer of the neural network f; and
   Aᵢ are the parameters of the activation function fᵢ.

In this case, the vectorized variable \vec{X} includes the input x (e.g., an image) and the parameters Aᵢ of the successive layer of the neural network f, that is:

$$\vec{X} = [ \begin{matrix}vec ( x ) \\ vec ( {A}_{1} ) \\ ⋮ \\ vec ( {A}_{p} )\end{matrix} ]$$

Furthermore, in this case, the processing unit is 8 is configured to first compute the Jacobian matrix of the neural network f with respect to input x and parameters A₁, . . . , Aₚ, as:

$${𝒥}_{f} ( X ) = [ {J}_{f}^{0} ( X ) , {γ}_{0}^{T} ⊗ {J}_{f}^{1} ( X ) , … , {γ}_{p - 1}^{T} ⊗ {J}_{f}^{p} ( X ) ]$$

where:
   y^{T} is the transpose of y;
   yᵢ is the output of the i^{th} layer of the neural network f;
   y₀ is the input x;
   ⊗ is a tensor product;
   J_{f}⁰ is the Jacobian matrix of the neural network f with respect to input x; and
   J_{f}ⁱ is the Jacobian matrix of the neural network f with respect to the parameters of the i^{th} layer, computed as:

$${J}_{f}^{i} ( X ) = {f}_{p}^{′} ( {A}_{p} {γ}_{p - 1} ) {A}_{p} {f}_{p - 1}^{′} ( {A}_{p - 1} {γ}_{p - 2} ) … {A}_{i + 1} {f}_{i}^{′} ( {A}_{i} {γ}_{i - 1} )$$

In other words, the first term of matrix [symbol] is the Jacobian matrix of the model with respect to input x, the second term is the Jacobian matrix with respect to parameters A₁ of the first layer of the model, and so on.

Furthermore, in at least one embodiment, in order to reduce computation cost, the vectorized variable \vec{X}, as an approximation, may not include the parameters Aᵢ of at least one layer i. In this case, the Jacobian matrix [symbol] (X) of the neural network f does not include the term yᵢ₋₁^{T}⊗J_{f}ⁱ(X) corresponding to each layer i having corresponding parameters Aᵢ not included in the vectorized variable \vec{X}.

Alternatively, in at least one embodiment, to reduce computation cost, the vectorized variable \vec{X} may, as an approximation, only include the input x. In this case, the Jacobian matrix [symbol] (X) of the neural network f is equal to the Jacobian matrix J_{f}⁰ of the neural network f with respect to input x.

Preferably, in at least one embodiment, the processing unit 8 is also configured to compare, during the decision step 24, the current condition number corresponding to the current instance of the model 12 (i.e., the condition number corresponding to the current iteration of the training loop 22) to the condition number associated with at least one previous iteration of the training loop 22.

In this case, in at least one embodiment, the processing unit 8 is configured to determine that the over-fitting condition is reached if an increase in the condition number is detected.

Conversely, in at least one embodiment, if the over-fitting condition is not reached, the processing unit 8 is configured to adjust parameters of the model 12 based on the current subset of the training dataset 10, during the adjustment step 26.

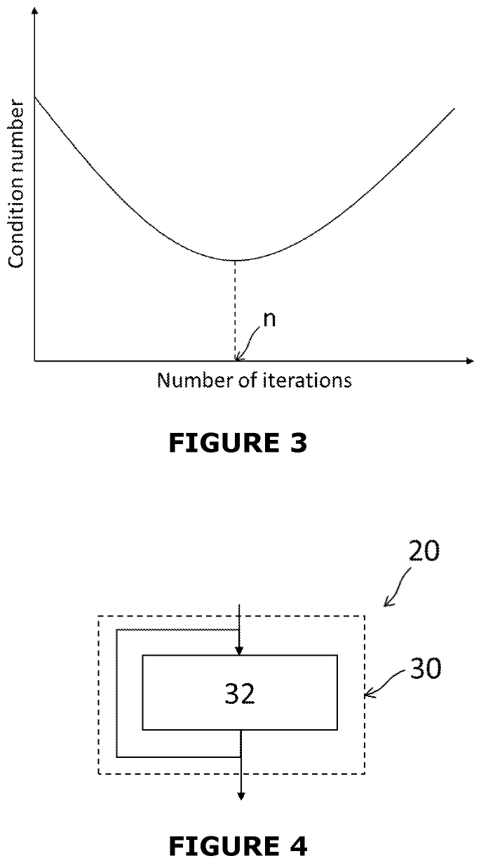

For instance, by way of one or more embodiments, in the example of FIG. 3, the over-fitting condition is reached for iteration n+1 of the training loop 22. Indeed, in this case, the minimum value of the condition number is reached at iteration n, as can be seen on the Figure, by way of one or more embodiments of the invention.

For example, to perform such adjustment, the processing unit 8 is configured to modify said parameters so that a difference between, on the one hand, outputs of the model 12 computed based on the inputs of the current subset, and, on the other, the corresponding expected outputs, reaches a minimum.

Preferably, in at least one embodiment, the updated model 12, which is the model 12 obtained once the adjustment step 26 is performed, is stored in the memory 6.

Furthermore, in at least one embodiment, said updated model 12 is the model that is considered during the decision step 24 of the next iteration of the training loop 22.

On the other hand, if the over-fitting condition is reached, the processing unit 8 is configured to stop the training of the model 12, during the stopping step 28.

Preferably, in at least one embodiment, in this case, the processing unit 8 is also configured to output, during the stopping step 28, as the trained model 16, the instance of the model 12 which is associated with the lowest condition number.

Preferably, the trained model 16 is stored in the memory 6.

A second example of the training method 20 is shown on FIG. 4, according to one or more embodiments of the invention.

The training method 20 of FIG. 4, in at least one embodiment, differs from the training method 20 of FIG. 2 in that the training loop, referenced 30 comprises an optimization step 32 for adjusting parameters of the artificial intelligence model, based on the current subset of the training dataset 10, to minimize a loss function.

In this case, in at least one embodiment, the updated model 12 obtained once the optimization step 32 is performed is the model that is considered during the optimization step 32 of the next iteration of the training loop 30.

Advantageously, in at least one embodiment, the loss function is an increasing function of the condition number of the model 12.

This feature is advantageous, as it allows penalizing models that have a higher condition number, thereby leading to trained models that are robust.

Preferably, in at least one embodiment, the loss function is equal to a sum of:
a first term that is an increasing function of a difference between, on the one hand, an output of the model 12 to a corresponding received input (i.e., the inputs of the current subset of the training dataset 10), and, on the other hand, an expected output associated with said received input;
a second term that is an increasing function of the condition number.

For instance, the loss function can be written as:

$$L ( A ) + a {κ}_{f} ( X )$$

where:
   L(A) is the aforementioned first term;
   ακ(X) is the aforementioned second term;
   α is a predetermined positive value;
   κ_{f} is the condition number;
   A represents the parameters of the artificial intelligence model 12; and
   X is the aforementioned variable including at least input x.

In this case, in at least one embodiment, the condition number κ_{f} may be computed using the technique described above in relation to the method of FIG. 2.

Naturally, in at least one embodiment, both examples of the training method can be combined. For instance, during the training loop 22 of FIG. 2, performing the adjustment step 26 may include adjusting parameters of the model 12, based on the current subset of the training dataset 10, to minimize a loss function that depends on the condition number, as described in relation to the optimization step 32 of the training loop 30 of FIG. 4, according to one or more embodiments of the invention.

### Operation

During an initial step, in at least one embodiment, a training dataset 10 is stored in the memory 6 of the computer 2, along with the artificial intelligence model 12 to train.

Then, in at least one embodiment, the processing unit 8 performs successive iterations of the training loop 22 for iteratively training the model 12.

More precisely, in at least one embodiment, during each iteration of the training loop 22, the processing unit 8 trains the model 12 based on a corresponding current subset of the training dataset 10, as well as based on a current condition number of the model 12, thereby resulting in an updated model 12.

More precisely, according to the example of FIG. 2, by way of one or more embodiments, during the decision step 24 of the training loop 22, the processing unit 8 computes the current condition number of the model 12 and determines whether an over-fitting condition is reached, based on the computed current condition number.

If the over-fitting condition is not reached, then, during the adjustment step 26, the processing unit 8 adjusts parameters of the model 12 based on the current subset of the training dataset 10.

On the other hand, if the over-fitting condition is reached, then, during the stopping step 28, the processing unit 8 stops the training of the model 12. In this case, the processing unit 8 preferably outputs, as the trained model 16, the instance of the model 12 associated with the lowest condition number.

Alternatively, in at least one embodiment, according to the example of FIG. 4, during the optimization step 32 of each iteration of the training loop 30, the processing unit 8 adjusts parameters of the artificial intelligence model 12, based on the current subset of the training dataset 10, to minimize a loss function that depends on the condition number of the artificial intelligence model 12.

Of course, the one or more embodiments of the invention are not limited to the examples detailed above.

1. A computer-implemented method for training an artificial intelligence model based on a training dataset, the computer-implemented method comprising:
iteratively performing a training loop for training the artificial intelligence model based on a current subset of the training dataset and on a current condition number of the artificial intelligence model, to update the artificial intelligence model.

2. The computer-implemented method according to claim 1, wherein the training loop comprises a decision step for determining, based on the current condition number of the artificial intelligence model, whether an over-fitting condition is reached,
wherein the training loop further comprises, based on a result of the determining, performing
an adjustment step for adjusting parameters of the artificial intelligence model based on the current subset of the training dataset if the over-fitting condition is not reached; or
a stopping step for stopping the training of the artificial intelligence model, if the over-fitting condition is reached.

3. The computer-implemented method according to claim 2, wherein the decision step comprises comparing the current condition number to a condition number associated with at least one previous iteration of the training loop, the over-fitting condition being reached if an increase in the condition number is detected.

4. The computer-implemented method according to claim 2, wherein the stopping step comprises outputting, as a trained model, an instance of the artificial intelligence model associated with a lowest condition number.

5. The computer-implemented method according to claim 1, wherein, for each iteration of the training loop, computing the current condition number comprises
computing, for each variable X associated with the current subset of the training dataset, a corresponding condition number as:
$${κ}_{f} ( X ) = \frac{‖ {𝒥}_{f} ( X ) ‖ ‖ \vec{X} ‖}{‖ γ ‖}$$
where:
κ_{f}(X) is the current condition number corresponding to variable X; [symbol]
(X) is a Jacobian matrix of the artificial intelligence model with respect to the variable X;
y is an output of the artificial intelligence model corresponding to the variable X;
X is a variable including at least an input x of the current subset of the training dataset, and at least part of parameters of the artificial intelligence model;
\vec{X} is a vectorized version of the variable X; and
determining the current condition number, for the current subset, based on the current condition number computed for said each variable X associated with the current subset.

6. The computer-implemented method according to claim 1, wherein the training loop comprises an optimization step for adjusting parameters of the artificial intelligence model, based on the current subset of the training dataset, to minimize a loss function that is an increasing function of the current condition number of the artificial intelligence model.

7. The computer-implemented method according to claim 6, wherein the loss function is equal to a sum of:
a first term that is the increasing function of a difference between, on one hand, an output of the artificial intelligence model to a corresponding received input, and, on another hand, an expected output associated with said corresponding received input;
a second term that is the increasing function of the current condition number.

8. A computer program comprising instructions, which when executed by a computer, cause the computer to carry out a computer-implemented method for training an artificial intelligence model based on a training dataset, the computer-implemented method comprising:
iteratively performing a training loop for training the artificial intelligence model based on a current subset of the training dataset and on a current condition number of the artificial intelligence model, to update the artificial intelligence model.
